(19) United States
(12) Patent Application Publication
(10) Pub. No.: US 2006/0184710 A1
(43) Pub. Date: Aug. 17, 2006

(54) Bridge between a single channel high speed bus and a multiple channel low speed bus

(75) Inventors: David A. Valdivia, Hayward, CA (US); Jayagopal Karuppampalayam, Cupertino, CA (US); James B. Lappin JR., San Francisco, CA (US)

Correspondence Address: DARBY & DARBY P.C., P.O. BOX 5257, NEW YORK, NY, 10150-6257, US

(73) Assignee: Nokia Inc., Irving, TX (US)

(21) Appl. No.: 11/061,709

(22) Filed: Feb. 17, 2005

(51) Int. Cl. G06F 13/36

(52) U.S. Cl. 710/315

(57) ABSTRACT

An apparatus for enabling communication between components in a network device includes a network processor providing data signals based on a PLx format; a multiport I/O controller having an IX bus interface and a plurality of MAC layer interfaces; and a bridge for bi-directionally converting the streaming data from the network processor to the I/O controller.

### BACKGROUND OF THE INVENTION

1. Field

The inventions are directed to interfaces for network devices, and more particularly, to a bridge for enabling communication between a single channel high speed bus and a multiple channel low speed bus.

2. Background

Over the last ten years, network devices have had to employ an ever increasing amount of resources to handle communication links with other nodes on a network and relatively complex communication protocols. To provide these additional resources, some network devices have significantly increased their memory and processing capacity (multi-processors, faster clock cycles, and the like). Other network devices have employed separate network processors to process most tasks associated with handling communication links and communication protocols. These network processors enable network devices to operate effectively in a large network with complex communication protocols without significantly increasing memory or processing capacity.

Some network processors can provide different interfaces with different capacities for communicating with the network device's input/output (I/O) cards. Typically, these I/O cards handle communications at the Media Access Control (MAC) layer and the layers below as identified in the “OSI model” for network communication. However, different types of interfaces may have different data carrying capacities and may not be widely supported by most I/O cards (often provided by third parties).

### BRIEF SUMMARY OF THE INVENTION

One embodiment is an apparatus for enabling communication between components in a network device. The apparatus includes a network processor providing data signals based on a PLx format; a multiport I/O controller having an IX bus interface and a plurality of MAC layer interfaces; and a bridge for bi-directionally converting the streaming data from the network processor to the I/O controller.

Another embodiment is a method of transmitting data from a network processor device providing data signals based on a PLx format to a multiport I/O controller having an IX bus interface. The method includes transmitting data from a network processor device to a bridge over a PLx interface. The data is transmitted from the bridge to the multiport I/O controller over the IX bus interface.

Yet another embodiment is an apparatus for enabling communication between components in a network device. The apparatus includes means for transmitting data from a network processor device over a PLx interface; and means for transmitting the data to the multiport I/O controller over the IX bus interface.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic block diagram of one embodiment of a network device that includes a PLx interface for communication with a MAC layer, according to the inventions;

FIG. 2 is a schematic block diagram of one embodiment of bridge between a PLx interface and an IX bus interface, according to the inventions;

FIG. 3 is a schematic block diagram of one embodiment of the transmit PLx interface of the bridge of FIG. 2;

FIG. 4 is a schematic block diagram of one embodiment of the receive PLx interface of the bridge of FIG. 2;

FIG. 5 is a schematic block diagram of one embodiment of the transmit IX Bus interface of the bridge of FIG. 2;

FIG. 6 is a schematic block diagram of one embodiment of the receive IX Bus interface of the bridge of FIG. 2;

FIG. 7 is a flow chart of one embodiment of a method for flow control of data through a transmit FIFO, according to the inventions;

FIG. 8 is a flow chart of one embodiment of a method for transmitting data from transmit FIFOs of a bridge to a MAC layer, according to the inventions; and

FIG. 9 is a flow chart of one embodiment of a method for transmitting data from a MAC layer to receive FIFOs of a bridge, according to the inventions.

### DETAILED DESCRIPTION OF THE INVENTION

The inventions are directed to interfaces for network devices, and more particularly, to a bridge for enabling communication between a single channel high speed bus and a multiple channel low speed bus.

Briefly stated, the invention is directed to a network device that includes an apparatus (such as a bridge) that enables a relatively high speed communication interface from a network processor unit to be converted into a multiple channel low speed communication interface that is generally supportable by an I/O card in a network device. The relatively high speed communication interface can be a single channel interface. The term “single channel” also includes devices that have a single transmit channel and a single receive channel.

The high speed communication interface provided by the network processor is typically a PLx interface, including, but not limited to, POS-Phy Level 3 (PL3), POS-Phy Level 4 (PL4), SPI 3, SPI 4.2, and the like. An example of a PL3 interface is described in the POS-PHY™ Level 3 compatibility specification from PMC-Sierra, Inc., PMC-1980495, Issue 4 (June 2000), incorporated herein by reference. The network devices can include, routers, base stations, access nodes, switches, firewalls, gateways, bridges, and the like.

In one embodiment, the I/O card is configured as an Ethernet card that provides support for a plurality of communication links on a network. In one embodiment, the I/O card is configured to support a multi-port IX Bus Interface, such as the IX Bus Interface provided by the IXF440 Multiport 10/100 Mbps Ethernet Controller from Intel™.

In one embodiment, the bridge is implemented in an application specific integrated circuit (ASIC) or in a FPGA (Field Programmable Gate Array) that is provided to the network device. The bridge can be included on the I/O card or as a component that can be coupled to the I/O card. In one embodiment, the relatively high speed communication interface operates at a clock speed that is substantially greater than the clock speed of the multiple channel communication interface. For example, a PL3 interface could be clocked at approximately 100 MegaHertz and an IX Bus Interface could be clocked at approximately 66 MegaHertz.

Illustrative Operating Environment

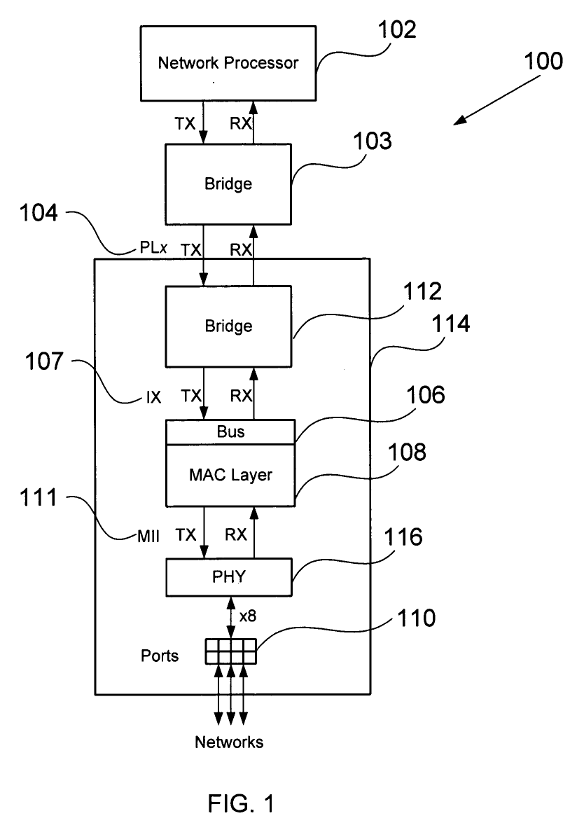

FIG. 1 illustrates a block diagram generally showing components included in network device 100 (e.g., a network appliance) that are configured to employ the PLx interface to communicate over a network. Although other components for handling the general operation of the network device are not shown, they can also include Read Only Memory (ROM), Random Access Memory (RAM), power supply, flash memory, hard disk, pointing device interface, keyboard interface, software applications, and the like.

The network device includes a network processor 102 that can communicate via one or more PLx interfaces 104. Optionally, a bridge 103 exists between the network processor 102 and the PLx interface 104. In one embodiment, the network processor communicates through a PLx interface for transmission of packets and for receiving packets. The network processor may also utilize one or more PCI interfaces for device and card configuration. As one example, network processor 102 may be provided by Broadcom Company (Irvine, Calif.), such as part no. BCM1250. Examples of suitable network processors with PLx interfaces include, but are not limited to, those disclosed in U.S. patent application Ser. No. 10/881,854, incorporated herein by reference.

An I/O card 114 of the network device can include a bus 106, MAC layer components 108 for processing MAC layer signals, and a physical layer 116 connected to the MAC layer by the media independent interface (MII) 111. In one embodiment, the I/O card provides physical Ethernet ports or other interfaces 110 to an internal and/or external network. In another embodiment, the I/O card can provide other types of interfaces to internal and/or external networks. In at least some embodiments, a plurality of Ethernet ports or other interfaces are provided. In the embodiment illustrated in FIG. 1, eight Ethernet ports are provided. A bridge 112 is provided between the PLx interface(s) 104 and the bus 106, such as a bus with an IX interface 107, to convert the relatively high speed PLx signals to lower speed signals for the bus and MAC layer.

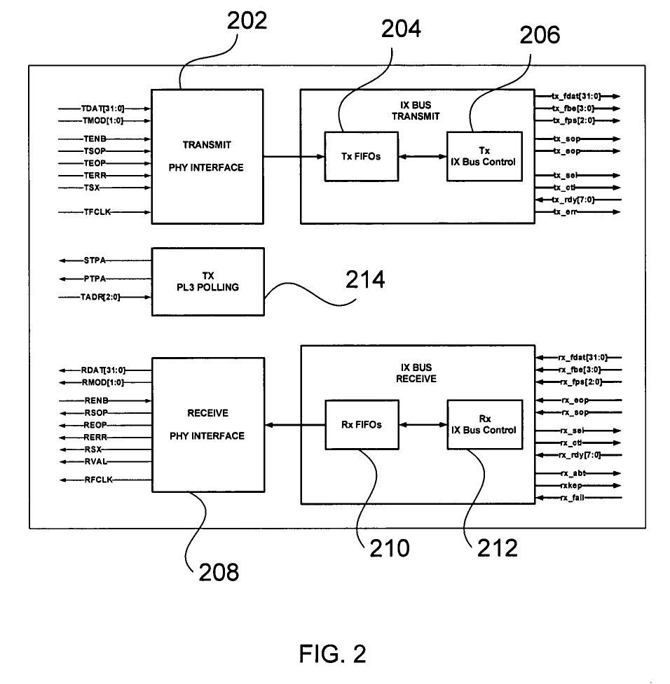

FIG. 2 illustrates a block diagram of bridge 112. The bridge includes a transmit PLx interface 202, one or more transmit FIFOs (first in, first out units) 204, transmit bus interface 206, receive PLx interface 208, one or more receive FIFOs 210, receive bus interface 212, and transmit PLx polling module 214. In the description below, the exemplified embodiment has 8 transmit FIFOs and 8 receive FIFOs. It will be recognized that more or fewer FIFOs can be used and that the number of transmit FIFOs and the number of receive FIFOs need not be the same.

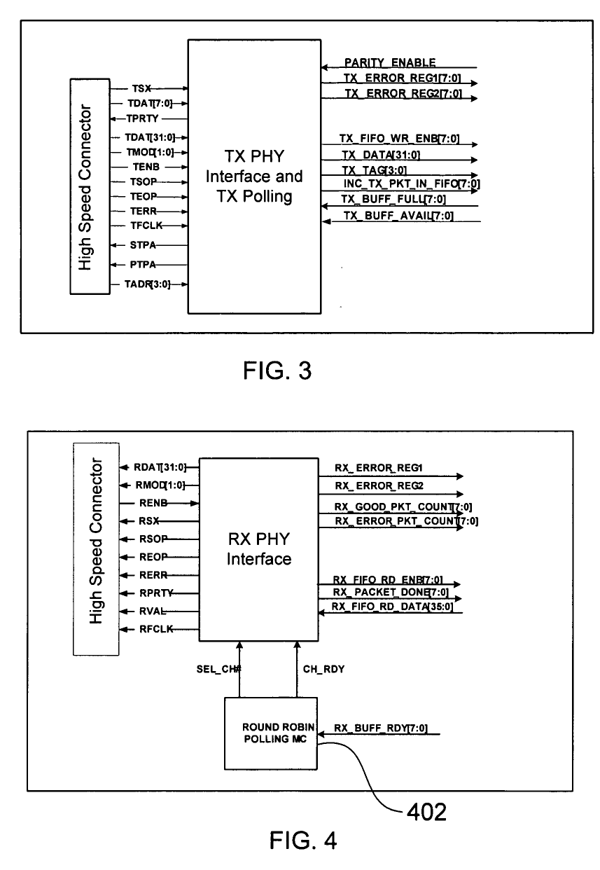

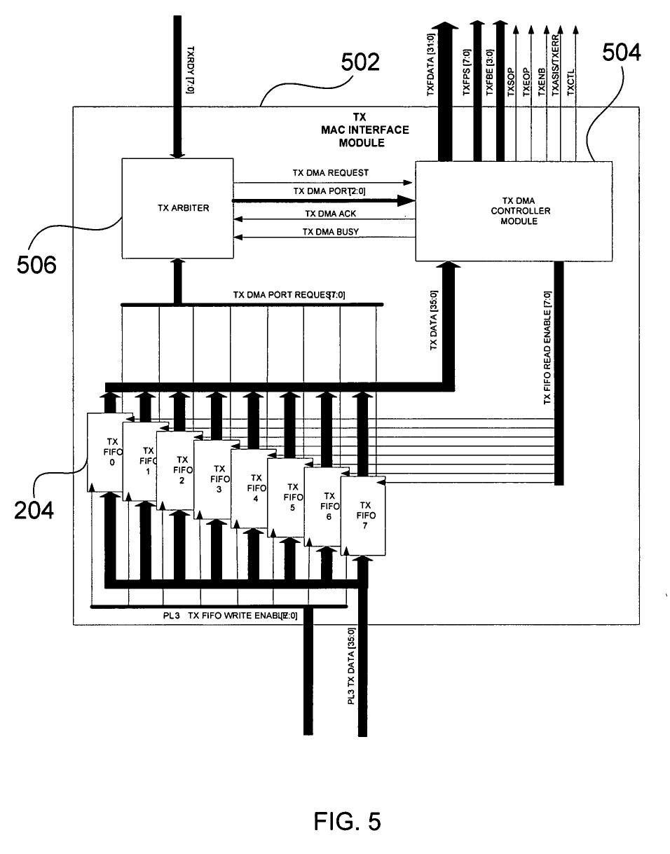

FIG. 3 is a block diagram of one embodiment of the transmit PLx interface 202 and transmit PLx polling module 214 and FIG. 4 is a block diagram of one embodiment of the receive PLx interface 208. The transfer of data can occur when reading or transmission is enabled by asserting RENB/TENB, respectively.

The transmit PLx interface and receive PLx interface are point-to-point buses, which can optionally support variable length packets. This can be accomplished by providing a frame based transmission and reception method. Each packet is associated with a Start of frame (RSX/TSX), Start of packet (RSOP/TSOP) and End of packet (REOP/TEOP). If variable length packet transfer is used, a modulus (RMOD/TMOD), sent at End of packet, indicates the number of valid bytes in the last word of the packet transmission. As an example, RMOD[1:0]/TMOD[1:0] with value “00” can signify 4 valid bytes, “01” can signify 3 valid bytes, “10” can signify 2 valid bytes, and “11” can signify 1 valid byte. In one embodiment, communication occurs using 32-bit data structures (RDAT[31:0]/TDAT[31:0]). Other data structures, including data structures of sizes other than 32 bits, can be used, however, for the discussion below a 32-bit data structure will be exemplified. It will be understood that the size of the data structure, as well as other data structure characteristics, can be altered for a particular embodiment.

An RERR/TERR is also provided to indicate any error in the completed packet and odd parity is used (RPRTY/TPRTY). In one embodiment, the target clock rate (TFCLK/RFCLK) for the PLx interface is 100 Mhz. This will provide an aggregate bit rate of 3.2 Gbit/s (32 bits×100 MHz) in each direction.

When the host initiates a packet transfer on the PLx egress, the channel address present on the data lines TDAT[7:0] at the start of the frame is decoded to select the corresponding transmit FIFO 204 for the channel. At this point if the FIFO indicates a buffer available condition, the packet data from the PLx data lines are sequentially written into the selected FIFO until an end of packet is received on the PLx interface. At the end of the packet, a TX_GOOD_COUNTER can be incremented for the channel, if there were no errors detected in the packet (protocol errors, parity error or TERR). If, however an error was detected, the packet will be completed in the FIFO with an error and a TX_ERROR_COUNTER can be incremented. INC_TX_PKT_IN_FIFO [7:0] directs incrementing the transmission packet in the FIFO.

Along with the 32 bit data, a 4 bit tag is also written into the FIFO to qualify the data word that is written. An example of possible TAGs is provided in Table 1.

TABLE 1

| Tag | QUALIFICATION |
|---|---|
| 0000 | Packet boundary |
| 0001 | Start of Packet word |
| 0010 | Middle of packet word |
| 0011 | Status word |
| 0100 | Unused |
| 0101 | Unused |
| 0110 | Unused |
| 0111 | Unused |
| 1000 | End of packet with 4 valid bytes in last word |
| 1001 | End of packet with 3 valid bytes in last word |
| 1010 | End of packet with 2 valid bytes in last word |
| 1011 | End of packet with 1 valid byte in last word |
| 1100 | End of packet with ERROR |
| 1101 | Unused |
| 1110 | Unused |
| 1111 | Unused |

For the purpose of flow control, a FIFO control module can provide two signals on a per port basis, the TX_BUFF_AVAIL and TX_BUFF_FULL. The TX_BUFF_AVAIL is asserted when the FIFO is empty and gets deasserted when the number of words written (and unread) in the FIFO reaches a predetermined value. In at least some embodiments, this predetermined value is configurable by the user or designer. This is an early warning and depends on the value programmed into the TX_THRESHOLD_REG. Once this signal is deasserted by the FIFO control, the transmit PLx polling interface in turn, deasserts the PTPA and the STPA signals for this port. The software then spots queuing any more packets to this port. However, the device will still be able to receive and store in the FIFO a certain number of words which is controlled by the TX_OFFSET_REG value. When the number of unread words in the FIFO reaches a value equal to the “threshold+offset”, then the FIFO control module asserts TX_BUFF_FULL. In another embodiment, instead of setting an offset value, a full value (equal to the sum of the threshold and offset values) can be used where TX_BUFF_FULL is asserted when the number of unread words reaches the full value. When the TX_BUFF_FULL condition is reached, the current packet is terminated in the FIFO with error. The TX_ERROR REG1 is updated with the FIFO not available status. The PL3_TX_ERROR_COUNTER for the channel is incremented.

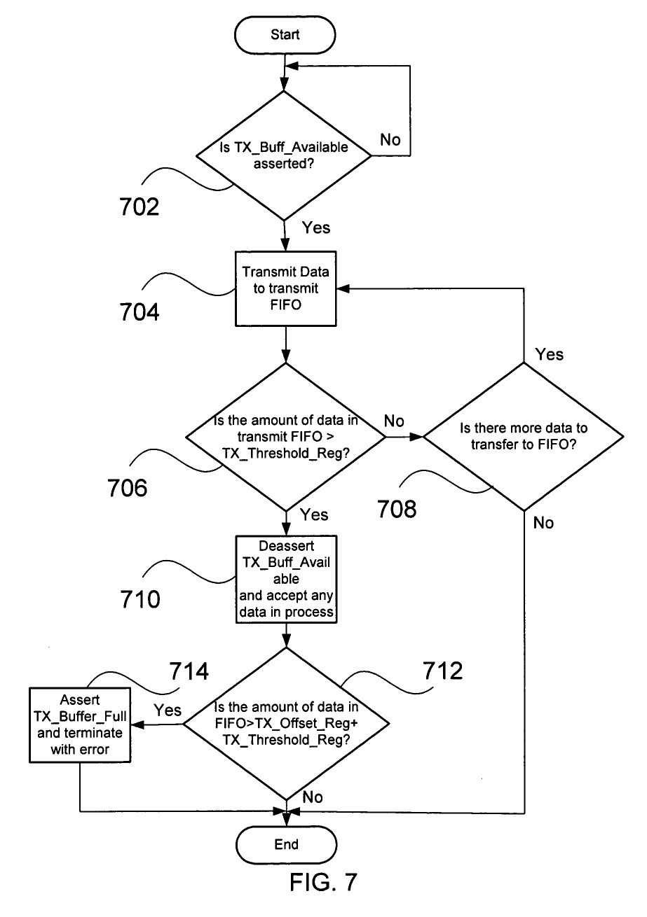

One example of transmit flow control is illustrated in flow chart format in FIG. 7. After an initial start block, the transmit PLx interface determines whether TX_BUFF_AVAILABLE is asserted for the transmit FIFO indicated by TDAT [7:0] (step 702). If it is not asserted, no data is sent to the transmit FIFO. If it is asserted, then transmit data is sent to the selected transmit FIFO (step 704). When the data has been transmitted (or, optionally, during transmission) if the amount of data in the transmit FIFO does not exceed TX_THRESHOLD_REG (step 706), data is sent to the transmit FIFO until the packet is completed.

Before the end of the packet, if TX_THRESHOLD_REG is exceeded (step 706) then TX_BUFF_AVAIL is deasserted (step 710). In at least some embodiments, any data in the process of being transmitted to the selected transmit FIFO is still sent to the FIFO. No additional data is sent to that particular transmit FIFO until TX_BUFF_AVAILABLE is reasserted. If the amount of data in the transmit FIFO subsequently increases to an amount greater than the sum of TX_THRESHOLD_REF and TX_OFFSET_REG (step 712) then TX_BUFF_FULL is asserted and the transmit FIFO is terminated with an error (step 714); otherwise the data in the transmit FIFO is eventually transmitted to the MAC layer.

In one embodiment, the transmit FIFOs are capable of receiving 4 K bytes. The TX_THRESHOLD_REG is set at 1522 bytes and the TX_OFFSET_REG is set at 3040 bytes.

Tables 2 and 3 provide examples of errors indicated by TX_ERROR_REG1 and TX_ERROR_REG2, respectively. TX_ERROR_REG2 is used primarily for debugging.

TABLE 2

| Bit Name | Bit No. | Bit Description |
|---|---|---|
| TXERR | 7 | OR of all errors in bits 6 to 3 |
| PARERR | 6 | Parity error in PLx data lines |
| FNR | 5 | Fifo not ready for selected channel |
| MOPERR | 4 | PLx protocol error during middle of pkt |
| EOPERR | 3 | PLx protocol error at EOP |
| CHNO | 2:0 | Channel which reported the error |

TABLE 3

| Bit Name | Bit No. | Bit Description |
|---|---|---|
| — | 7 | Reserved |
| TX_STATE | 6:4 | FPGA TX state at error condition |
| TENB | 3 | State of PLx_TENB at error |
| TSX | 2 | State of PLx_TSX at error |
| TSOP | 1 | State of PLx_TSOP at error |
| TEOP | 0 | State of PLx_TEOP at error |

A polling machine continuously updates the PTPA line with the buffer available status from the transmit FIFOs. This reflects the status of the transmit FIFO selected by the TADDR[2:0] lines on the PLx interface. Also, the minimum amount of space that is available in the transmit FIFO to indicate the ready status is programmed into the transmit PLx FIFO threshold register.

FIG. 4 is a block diagram of the receive PLx interface 208. An internal polling machine 402 does a round robin poll of all the eight RX_BUFF_RDY signals, coming from the receive FIFOs 210. At any point of time if the scanned channel has its ready status set, then the polling is stopped and the channel's FIFO is read and the data sent to the PLx lines as a receive packet. The framing is done to send the channel address on the RDAT[7:0] lines along with the RSX. The first data word is accompanied by the RSOP. The last word sent along with the REOP may contain a variable number of valid bytes which is indicated by the RMOD[1:0] signals.

The RENB signal can be used for flow control. For example, when the link layer device asserts RENB, 2 words in the pipeline are sent before the data transfer is paused and then resumed 2 clock cycles after RENB is deasserted.

The receive PLx interface looks for proper sequencing of the RSOP and the REOP tags in the FIFO and in case of errors, terminates the packet on the PLx with an RERR at REOP. In one embodiment, the case of a missing REOP tag in the FIFO, at most 1544 bytes may be sent on the PLx receive lines before terminating the packet with error. This is a reflection of a defined maximum size of 1.5 kb for a packet before declaring a missing REOP.

In an embodiment using an IX Bus as bus 106, the IXF440 can operate in a split IX mode. This allows the IXF440 to support concurrent unidirectional 32-bit data streams for both transmit and receive functions. A block diagram of the transmit FIFOs 204 and transmit bus interface 206 is provided as FIG. 5 and includes a hierarchical MAC (Media Access Control) interface 502 (based on layer 3 of the OSI (Open Systems Interconnection) Model), the DMA (Direct Memory Access) controller 504, the transmit arbiter 506, and the 8 individual FIFOs 204 to which the transmit PLx interface writes. The transmit bus interface can also contain various counter modules (not shown) for keeping track of the traffic within each of the transmit channels.

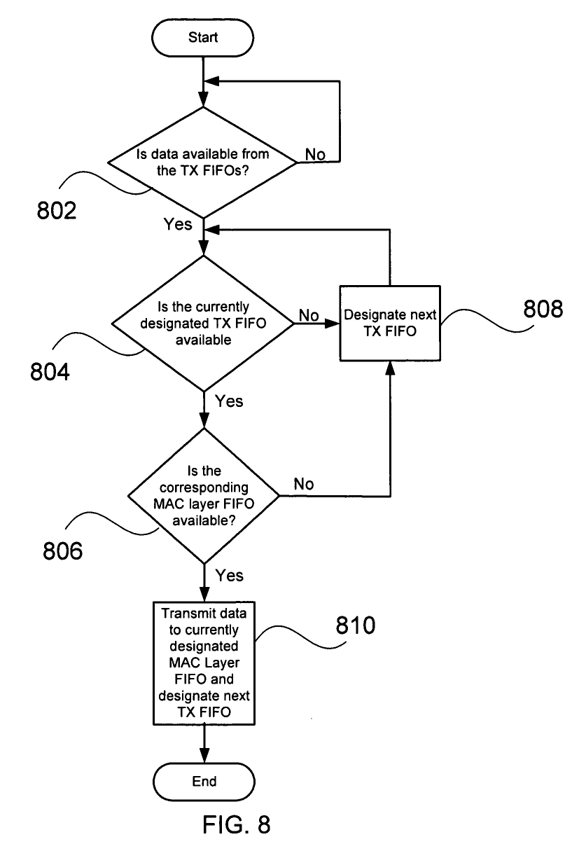

In one embodiment, the transmit arbiter 506 is a simple token passing round-robin arbiter. FIG. 8 illustrates one embodiment of a flow chart using the transmit arbiter. At the start of arbitration, the transmit arbiter using a TXDMAPortRequest [7:0] looks to see if any of the channels is requesting to transfer data to the MAC layer 108 via bus 106 (step 802). If so, the channel holding the token is polled to see if it has data to transmit to the MAC layer (step 804). If it does, and the TxRdy line indicates that the MAC layer has sufficient space in its corresponding FIFO for that channel (step 806), then the transmit arbiter 506 will signal the transmit DMA controller 504 with the assertion of the TxDMARequest signal as well as placing the channel number on the TxDMAPort[2:0] bus. The data is then transferred to the MAC layer FIFO (step 810). At this point the token is passed to the next channel in the round robin for use in the next arbitration cycle.

The transmit DMA controller 504 will acknowledge the request via the TxDMAAck signal and will also assert TxDMABusy during the transfer. The arbiter will wait until the TxDMABusy signal is deasserted before beginning another arbitration signal.

Should the current channel with the token not be one of the requesting channels, then the token is passed to the next channel in the round-robin circle (step 808). This process continues until the first requesting channel is encountered. Any method of selecting the next FIFO or channel to contain the token can be used.

The transmit DMA controller 504 is responsible for the transfer of data from the individual FIFO channels to the MAC layer. The transmit DMA controller 504 is signaled by the transmit arbiter 506, by way of the TxDMARequest line as well as the TxDMAPort[2:0] bus, as to which channel to service.

Once the port has been identified, the DMA Controller asserts the TXFIFOReadEnable [7:0] to the FIFO associated with the particular channel. Of the 36-bits read out of the transmit FIFO, 32-bits are the packet data, while the remaining 4 bits are used as a tag to indicate Start of Packet, End of Packet, Middle of Packet or Error. The data, as well as any corresponding control signal, are placed on the actual bus 106 (such as an IX Bus). The amount of data to be transferred, or burst, during any DMA service cycle is programmed in the bridge 112. Upon completion of the burst, the transmit DMA controller signals the arbiter to begin another arbitration cycle by deasserting the TxDMABusy signal. Application of the Txasis/Txerr signal is done according to the IXF440 Data Sheet.

In one embodiment, each of the eight transmit FIFOs 204 is a dedicated 1023 entry by 36-bit wide asynchronous FIFO. In one embodiment, each FIFO is written to using the transmit PLx Transmit Interface using the 100 MHz PLx clock. Data is read out in the 66 MHz domain of the IX Bus clock.

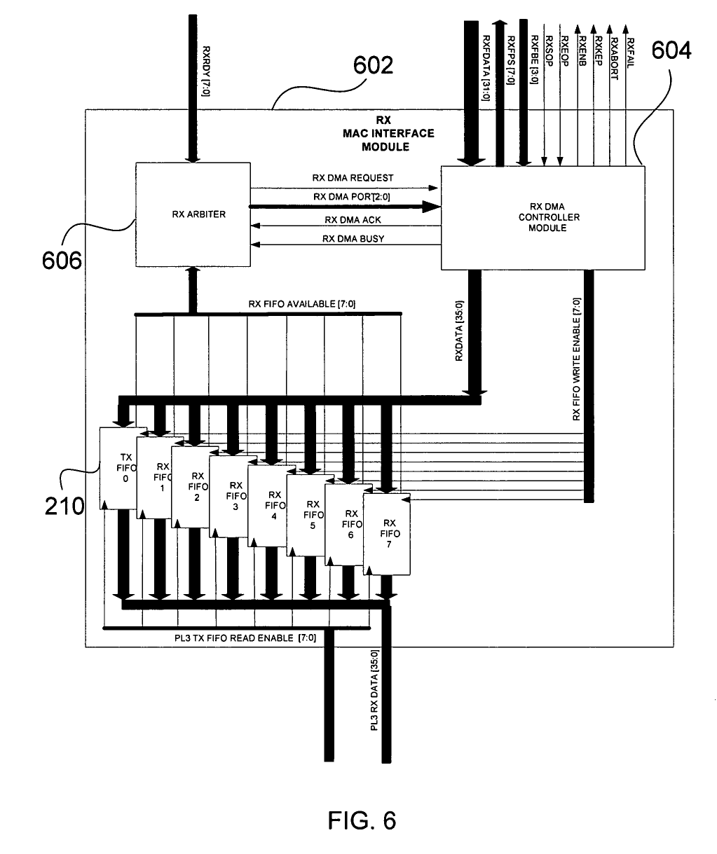

FIG. 6 illustrates the receive bus interface and includes a hierarchical MAC interface 602, the receive DMA controller 604, the receive arbiter 606, and the eight individual receive FIFOs 210 that are to be read by the receive PLx interface. The receive bus interface also can include various counter modules (not shown) for keeping track of the traffic within each of the receive channels.

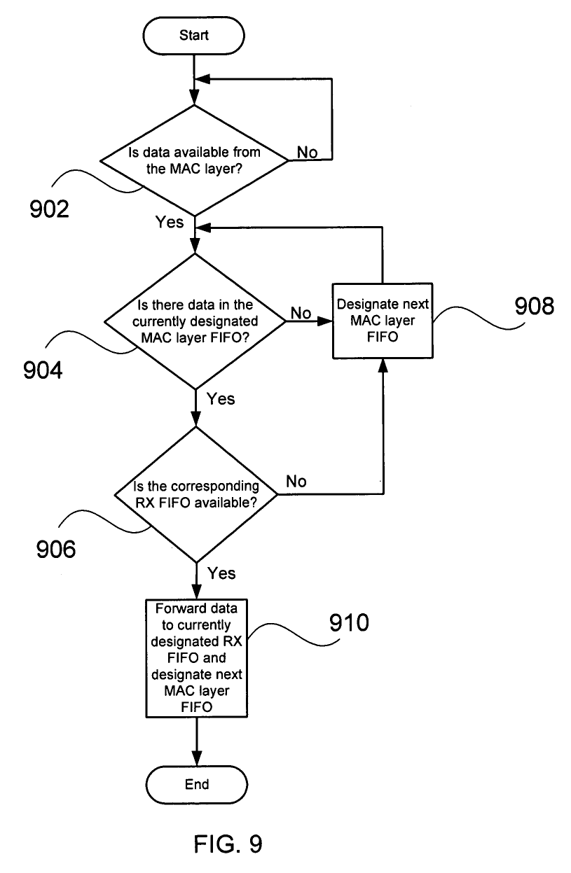

The receive arbiter 606 can be a simple token passing round-robin arbiter. One example of a flow chart for transferring data from the MAC layer to the receive FIFOs is illustrated in FIG. 9. At the start of arbitration, the receive arbiter looks to see if any of the MAC layer channels is requesting to transfer data, via the RxRdy signals, to the system (step 902). If so, the channel holding the token is polled to see if it has data to transmit to the PLx interface (step 904). If it does, and the FIFOAvailable line for the current channel indicates that there is sufficient space in the corresponding receive FIFO 210 (step 906), then the receive arbiter will signal the receive DMA controller 604 with the assertion of the RxDMARequest signal as well as placing the channel number on the RxDMAPort[2:0] bus. The data is then transferred to the appropriate receive FIFO (step 910). At this point the token is passed to the next channel in the round robin for use in the next arbitration cycle.

The receive DMA controller will acknowledge the request via the RxDMAAck signal and will also assert RxDMABusy during the transfer. The receive arbiter will wait until the RxDMABusy signal is deasserted before beginning another arbitration cycle.

Should the current MAC channel with the token not be one of the requesting channels, then the token is passed to the next MAC channel in the round-robin circle (step 908). This process continues until the first requesting MAC channel is encountered.

The receive DMA controller is responsible for the transfer of data from the MAC layer to the individual receive FIFOs of the bridge. The receive DMA Controller is signaled by the receive arbiter, by way of the RxDMARequest line as well as the RxDMAPort[2:0] bus, as to which MAC layer channel to service.

Once the port has been identified, the DMA Controller asserts the read enable to the MAC and upon the data being placed on the IX Bus, the appropriate write enable is asserted for the receive FIFO associated with the particular channel. The data, as well as the appropriate control signals are encoded to produce data “tags” and both data and tag are written to the FIFO. The amount of data to be transferred, or burst, during any DMA service cycle is programmed in the bridge. Upon completion of the burst, the receive DMA controller signals the arbiter to begin another arbitration cycle by deasserting the RxDMABusy signal. In one embodiment, each of the eight receive FIFOs in the bridge has a dedicated 1023 entry by 36-bit wide asynchronous FIFO. In one embodiment, each FIFO is written to, by the receive DMA controller, in the 66 MHz domain of the IX Bus clock. Application of the RxAbort, Rxkep and Rxfail signals are done according to the IXF440 Data Sheet.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. An apparatus for enabling communication between components in a network device, comprising:
a network processor providing data signals based on a PLx format;
a multiport I/O controller having an IX bus interface and a plurality of MAC layer interfaces; and
a bridge for bi-directionally converting the streaming data from the network processor to the I/O controller.

2. The apparatus of claim 1, wherein the bridge comprises a plurality of transmit FIFOs.

3. The apparatus of claim 2, further comprising a transmit arbiter and transmit DMA controller coupled to the transmit FIFOs and configured and arranged to facilitate transmission of data from the transmit FIFOs over the IX bus interface of the I/O controller.

4. The apparatus of claim 1, wherein the bridge comprises a plurality of receive FIFOs.

5. The apparatus of claim 4, further comprising a receive arbiter and receive DMA controller coupled to the receive FIFOs and configured and arranged to facilitate reception of data by the transmit FIFOs from the IX bus interface of the I/O controller.

6. The apparatus of claim 1, wherein the network processor has one PLx transmit channel and one PLx receive channel.

7. The apparatus of claim 1, wherein the PLx format is a PL3 format.

8. The apparatus of claim 1, wherein a clock speed of the network processor device is greater than a clock speed of the I/O controller.

9. The apparatus of claim 1, wherein the MAC layer interfaces are Ethernet ports.

10. A method of transmitting data from a network processor device providing data signals based on a PLx format to a multiport I/O controller having an IX bus interface, the method comprising:
transmitting data from a network processor device to a bridge over a PLx interface; and
transmitting the data from the bridge to the multiport I/O controller over the IX bus interface.

11. The method of claim 10, wherein transmitting the data from the network processor device to the bridge comprises transmitting the data from the network processor device to at least one of a plurality of transmit FIFOs of the bridge.

12. The method of claim 11, wherein transmitting the data to at least one of a plurality of transmit FIFOs comprises transmitting the data until the transmit FIFO indicates that the transmit FIFO has at least a predetermined amount of data stored in the transmit FIFO.

13. The method of claim 12, further comprising indicating to the network processor device that no more data should be sent to the transmit FIFO when at least the predetermined amount of data is stored in the transmit FIFO.

14. The method of claim 13, further comprising receiving data that has already been forwarded to the transmit FIFO prior to the transmit FIFO indicating to the network processor device that no more data should be sent to the transmit FIFO.

15. The method of claim 12, further comprising terminating the data with an error if the amount of data in the transmit FIFO exceeds a predetermined FIFO-full amount.

16. The method of claim 10, further comprising:
receiving data at the bridge from multiport I/O controller over the IX bus interface; and
receiving the data at the network processor device from the bridge over a PLx interface.

17. The method of claim 10, wherein the PLx interface is a PL3 interface.

18. An apparatus for enabling communication between components in a network device, comprising:
means for transmitting data from a network processor device over a PLx interface; and
means for transmitting the data to the multiport I/O controller over the IX bus interface.

19. The apparatus of claim 18, further comprising:
means for receiving data from multiport I/O controller over the IX bus interface; and
means for receiving the data at the network processor device over a PLx interface.

20. The apparatus of claim 18, wherein the PLx interface is a PL3 interface.
